(19) United States
(12) Patent Application Publication
(10) Pub. No.: US 2021/0383951 A1
(43) Pub. Date: Dec. 9, 2021

(54) STACKING WIRE WOUND RESISTOR AND MANUFACTURING METHOD THEREOF

(71) Applicant: FIRST RESISTOR & CONDENSER CO., LTD., Taipei City (TW)

(72) Inventor: Shang-Yo Lee, Taipei City (TW)

(73) Assignee: FIRST RESISTOR & CONDENSER CO., LTD., Taipei City (TW)

(21) Appl. No.: 17/334,833

(22) Filed: May 31, 2021

(30) Foreign Application Priority Data
Jun. 3, 2020 (TW) 109118653

(51) Int. Cl. H01C 3/16; H01C 1/14; H01C 17/04

(52) U.S. Cl. CPC H01C 3/16; H01C 17/04; H01C 1/14

(57) ABSTRACT

The invention relates to a stacking wire wound resistor and manufacturing method thereof. The stacking wire wound resistor comprises: a ceramic rod having a resistance value, and a basic insulating laser plated thereon, in which the ceramic road is provided with a first end and a second end; a first wire wound resistor, including a first metal wire, having a first wire head and a first wire tail, and wiring surround from the first end to the second end of the ceramic rod, wherein a first insulating layer is plated thereon; and at least a second wire wound resistor, being vertically stacked on the first wire wound resistor and the ceramic rod having a resistor value, and the ceramic rod having a resistor value, the first wire wound resistor and the second wire wound resistor are constituted into a predetermined circuit connection in parallel to raise the ability of anti-surge.

### CROSS-REFERENCE TO RELATED APPLICATIONS

The present application claims priority to Taiwan Patent Application No. 109118653 filed on Jun. 3, 2020, which is incorporated herein by reference in their entireties.

### TECHNICAL FILED

The invention relates to a stacking wire wound resistor and manufacturing method thereof, in particular to a stacking wire wound resistor comprising at least two wire wound resistors stacking together with a predetermined circuit connection to enhance anti-surge property.

### BACKGROUND ART

In the electronic industry, a wire wound resistor is mainly adapted for use in an alternative current or a DC circuit of a precise instrument meter, medical equipment, telecommunication instrument or electronic equipment, serving as a resistor for voltage division, voltage reduction, current shunting or loading, or otherwise providing an anti-surge function to prevent an electronic circuit from damage resulting from a surge current generated by a transient high voltage. However, as the transient voltage is too high, a general wire wound resistor is unable to withstand and thus broken, rendering the circuit out of operation, in which the ceramic rod of the wire wound resistor itself does not provide a resistance value. On the other hand, a Japanese patent No. 3208923 and a corresponding U.S. Pat. No. 9,978,483, issued to the same inventor of the instant application, disclose an anti-surge wire wound resistor and a manufacturing method thereof, mainly designed to electroplate a cap electroplated layer respectively at one end on a cap of the wire-wound resistor, which is indeed capable of enhancing anti-surge capability to an extent.

Further, for a specific application in some electronic equipments, such as a Defibrillator, it meets with the need of adopting a transient voltage several times. In the mean time, it is eagerly desired and particularly expected for the provision of a wire wound resistor with a simple structure to be competent for protection and safe operation of the circuit.

As such, it is expected in the industry to develop a wire wound resistor capable of effectively resisting the surge voltage so as to maintain a safe and normal operation of the electronic equipments.

### SUMMARY OF THE INVENTION

It is an objective of the invention to provide a stacking wire wound resistor and manufacturing method thereof, capable of enhancing anti-surge property at least several times higher than the conventional wire wound resistors as the transient voltage is higher than several Kv's, thereby maintaining sage and normal operation of the electronic circuits or equipments.

It is a further objective of the invention to provide a stacking wire wound resistor having a simple structure so as to maintain a safe and normal operation for a specific application of electronic equipments requiring the use of a transient high voltage several times.

According to the invention, a stacking wire wound resistor is provided, comprising:

a ceramic rod provided with a resistance value, being plated with a basic insulating layer thereon and having a first terminal and a second terminal;
a first wire wound resistor, including a first metal wire, which has a first wire head and a first wire tail and is surrounding wound from the first terminal of the ceramic rod provided with a resistance value to the second terminal of the ceramic rod provided with a resistance value, and a first insulating layer, being plated over the first metal wire; and
a second wire wound resistor, including a second metal wire, which has a second wire head and a second wire tail and is surrounding wound over the first wire wound resistor from the first terminal of the ceramic rod provided with a resistance value to the second terminal of the ceramic rod provided with a resistance value, and a second insulating layer, being plated over the second metal wire,
whereby the second wire wound resistor is stacked on the first wire wound resistor and on the ceramic rod provided with a resistance value to form a multi-layered, stacking wire wound resistor, and the ceramic rod provided with a resistance value, the first wire wound resistor and the second wire wound resistor constitute a predetermined circuit connection to enhance anti-surge property.

Further, the invention provides a method for manufacturing a stacking wire wound resistor, comprising the following steps:

providing a ceramic rod provided with a resistance value, and plating a basic insulating layer thereon, in which the ceramic rod provided with a resistance value has a first terminal and a second terminal;
forming a first wire wound resistor by providing a first metal wire, which has a first wire head and a first wire tail, winding the first metal wire from the first terminal of the ceramic rod to the second terminal of the ceramic rod provided with a resistance value, and plating a first insulating layer over the first metal wire; and
forming a second wire wound resistor by providing a second metal wire, which has a second wire head and a second wire tail, winding the second metal wire from the first terminal of the ceramic rod provided with a resistance value to the second terminal of the ceramic rod provided with a resistance value, and plating a second insulating layer over the second metal wire,
whereby the second wire wound resistor is stacked on the first wire wound resistor and on the ceramic rod provided with a resistance value to form a multi-layered, stacking wire wound resistor, and the ceramic rod provided with a resistance value, the first wire wound resistor and the second wire wound resistor constitute a predetermined circuit connection to enhance anti-surge property.

### BRIEF DESCRIPTION OF THE DRAWINGS

FIG. 1 shows an embodiment of the invention illustrating a stacking wire wound resistor with a two-layered, vertically stacking structure.

FIG. 2 shows a further embodiment of the invention illustrating a stacking wire wound resistor with a three-layered, vertically stacking structure.

FIG. 3 shows a still further embodiment of the invention illustrating an inductance less stacking wire wound resistor with two metal wires wound in a reverse direction.

Table 1 lists a 5 kv test report on comparison between the present invention and a conventional wire wound resistor for use in a Defibrillator.

### DETAILED DESCRIPTION OF THE INVENTION

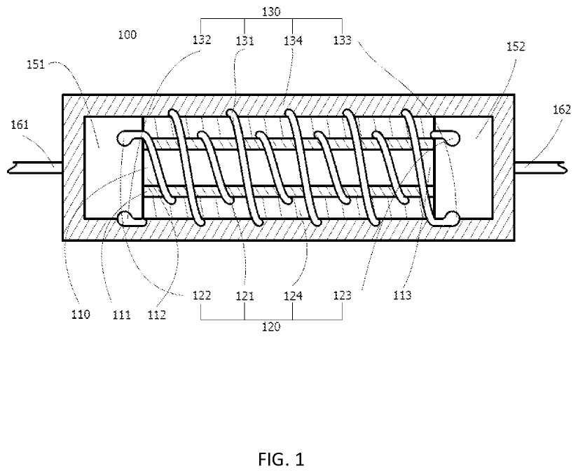

In FIG. 1, according to an embodiment of the invention, a stacking wire wound resistor 100 is shown, comprising:

a ceramic rod provided with a resistance value 110, being plated with a basic insulating layer 111 thereon and having a first terminal 112 and a second terminal 113, while in comparison, the ceramic rod of a conventional wire wound resistor does not have a resistance value;
a first wire wound resistor 120, including a first metal wire 121, which has a first wire head 122 and a first wire tail 123 and is surrounding wound from the first terminal 112 of the ceramic rod provided with a resistance value 110 to the second terminal 113 of the ceramic rod provided with a resistance value 110, and a first insulating layer 124, being plated over the first metal wire 121; and
a second wire wound resistor 130, including a second metal wire 131, which has a second wire head 132 and a second wire tail 133 and is surrounding wound over the first wire wound resistor 120 from the first terminal 112 of the ceramic rod provided with a resistance value 110 to the second terminal 113 of the ceramic rod provided with a resistance value 110, and a second insulating layer 134, being plated over the second metal wire 131,
whereby the second wire wound resistor 130 is stacked on the first wire wound resistor 120 and on the ceramic rod provided with a resistance value 110 to form a multi-layered, stacking wire wound resistor 100, and the ceramic rod provided with a resistance value 110, the first wire wound resistor 120 and the second wire wound resistor 130 constitute a predetermined circuit connection, being in parallel or in series, to enhance anti-surge property.

According to the stacking wire wound resistor 100 of the invention, the predetermined circuit connection is in parallel, or the first metal wire and the second metal wire are wound inversely to form an inductor less resistor.

With respect to the material, the ceramic rod provided with a resistance value 110 is a solid ceramic resistance rod, or a ceramic rod of high heat-dissipation with a heat-dissipation coefficient of 10 W/mk, combined with a metal film, a metal oxide film, a carbon film or a glass glaze.

Further, the stacking wire would resistor of the invention further comprises a first cap 151 and a second cap 152, being disposed respectively at one end of the ceramic rod provided with a resistance value 100 and extending outwardly from the first terminal 112 and the second terminal 113 thereof, wherein the first wire head 122 and the second wire head 132 as well as the first wire tail 123 and the second wire tail 133 are respectively soldered onto a surface of the first cap and a surface of the second cap, wherein the first cap 151 and the second cap 152 are respectively electroplated with a first electroplated layer and a second electroplated layer (not shown in the drawing). Further, during plating, the plating of the basic insulting layer 111 and the first insulating layer 124 do not cover on the first cap 151 and the second cap 152, and after completion that the second metal wire 131 is surroundingly wound from the first terminal 112 to the second terminal 113 of the ceramic rod provided with the resistance value 110, soldering points of the wire head and the wire tail respectively of the first metal wire 121 and the second metal wire 131 are electroplated together for strengthening, and at the time of plating the second insulting layer 134 for packing, the first cap 151 and the second cap 152 are plated as well.

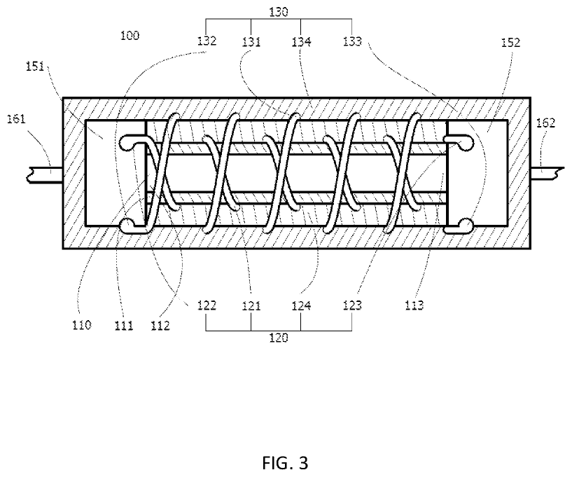

In addition, as shown in FIG. 1, in the structure of the two-layered stacking wire wound resistor, the plating of the outer layer of the second insulating layer includes platting of the first cap 151 and the second cap 152. As shown in FIG. 3, the plating of the third insulating layer includes the plating covering on the first cap 151 and the second cap 152. That is, in the multi-layered stacking wire wound resistor of the invention, the insulation layer plated on the upper-most layer of the wire wound resistor is to include the plating covering the two sides of the caps.

Furthermore, the stacking wire wound resistor 100, 100′ of the invention further comprises two externally connected metal leads 161, 162, respectively extending outwardly along an axial direction respectively of the first cap 151 and the second cap 152 from the first electroplated layer and the second electroplated layer for external electrical connection.

In the invention, the material of the first cap and second cap is iron, silver, nichrome, copper or other alloy, and the material of the first insulating layer, the second insulating layer and the third insulating layer is epoxy resin, silicone non-combustible paint, or enamel paint.

On the other hand, the material of the externally connected metal leads is copper alloy for raising heat-dissipating.

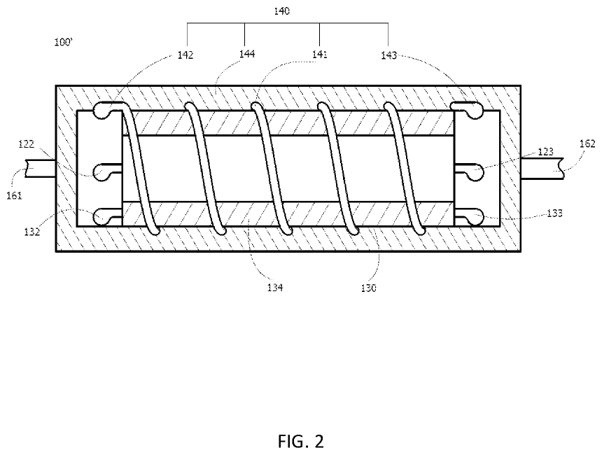

On the basis of such a structure, the wire wound resistor of the invention may be constructed by stacking at least a third wire wound resistor thereon (in detail, please refer to FIG. 2), such as to stack a third-layered, a fourth layer wire-wound resistor, depending on the need of the resistance value and the anti-surge voltage.

The stacking wire wound resistor of the invention comprises at least one further stacked wire wound resistor, such as a third wire wound resistor and/or a fourth wire wound resistor, to stack sequentially on the second wire wound resistor, as shown in FIG. 2.

FIG. 2 shows the structure of stacking a third wire wound resistor. As shown in FIG. 2, according to a further embodiment of the invention, a stacking wire wound resistor 100′ comprises a third wire wound resistor 140, which is stacked on the second wire wound resistor 130 to become a three-layered, stacking resistor, and includes a third metal wire 141, having a third wire head 142 and a third wire tail 143 and being surrounding wound over the second wire wound resistor 130 from the first terminal 112 of the ceramic rod provided with a resistance value 110 to the second terminal 113 of the ceramic rod provided with a resistance value 110, and a third insulating layer 144, being plated over the third metal wire 141, wherein the third wire wound resistor 140 is vertically stacked on the second wire wound resistor 130, and wherein the ceramic rod provided with a resistance value 110, the first wire wound resistor 120, the second wire wound resistor 130 and the third wire wound resistor 140 are connected in parallel.

Further, in FIG. 3, the stacking wire wound resistor 100 of the still further embodiment of the invention may be wired that the first metal wire 121 of the first wire wound resistor 120 and the second metal wire 131 of the second wire wound resistor 130 are wound in a reverse direction to enable the stacking wire wound resistor becoming an inductance less resistor.

The invention further provides a method for manufacturing a stacking wire wound resistor 100, comprising the following steps:

providing a ceramic rod provided with a resistance value 110, and plating a basic insulating layer 111 thereon, in which the ceramic rod provided with a resistance value has a first terminal 112 and a second terminal 113;
forming a first wire wound resistor 120 by providing a first metal wire 121, which has a first wire head 122 and a first wire tail 123, winding the first metal wire from the first terminal of the ceramic rod provided with a resistance value to the second terminal of the ceramic rod provided with a resistance value, and plating a first insulating layer 124 over the first metal wire; and
forming a second wire wound resistor 130 by providing a second metal wire 131, which has a second wire head 132 and a second wire tail 133, winding the second metal wire from the first terminal of the ceramic rod to the second terminal of the ceramic rod, and plating a second insulating layer 134 over the second metal wire,
whereby the second wire wound resistor is stacked on the first wire wound resistor and on the ceramic rod provided with a resistance value to form a multi-layered, stacking wire wound resistor 100, and the ceramic rod provided with a resistance value, the first wire wound resistor and the second wire wound resistor constitute a predetermined circuit connection to enhance anti-surge property.

The method for manufacturing a stacking wire wound resistor of the invention, further comprises the step of providing a third wire wound resistor 141, which is stacked on the second wire wound resistor, in which the predetermined circuit connection is in parallel as shown in FIG. 2, or the first metal wire and the second metal wire are wound inversely to form an inductor less resistor, as shown in FIG. 3.

The material of the ceramic rod provided with a resistance value is a solid ceramic resistance rod, or a ceramic rod of high heat-dissipation with a heat-conducting coefficient of 10 W/my, combined with a metal film, a metal oxide film, a carbon film or a glass glaze.

The method for manufacturing a stacking wire wound resistor of the invention further comprises the step of providing a first cap 151 and a second cap 152, being disposed respectively at one end of the ceramic rod provided with a resistance value and extending outwardly from the first terminal and the second terminal thereof, wherein the first wire head and the second wire head as well as the first wire tail and the second wire tail are respectively soldered onto a surface of the first cap and a surface of the second cap, wherein the first cap and the second cap are respectively electroplated with a first electroplated layer and a second electroplated layer, and wherein during plating, the plating of the basic insulting layer and the first insulating layer do not cover on the first cap and the second cap, and after completion that the second metal wire is surrounding wound from the first terminal to the second terminal of the ceramic rod provided with the resistance value, soldering points of the wire head and the wire tail respectively of the first metal wire and the second metal wire are electroplated together for strengthening, and at the time of plating the second insulting layer for packing, the two caps are plated as well.

The method for manufacturing a stacking wire wound resistor of the invention further comprises the step of providing two externally connected metal leads 161, 162, respectively extending outwardly along an axial direction respectively of the first cap and the second cap from the first electroplated layer and the second electroplated layer.

According to the method for manufacturing a stacking wire wound resistor, the material of the first cap and second cap is iron, silver, nichrome, copper or the alloy. Further, the material of the first insulating layer, the second insulating layer and the third insulating layer is eposy resin, silicone non-combustible paint, or enamel paint. Furthermore, the material of the externally connected metal leads is copper alloy for raising heat-dissipating.

As shown below, Table 1 lists a 5 kv pulse test for a Defibrillator according to a test standard AANSI/AAMI EC53: 2013 IEC 60601-2-27: 2001, which is an Electrocardiography (ECG) medical standard (https://webstore.Iec.ch/publication/2638). As listed in the Table 1, the test condition is as follows.

Pulse voltage=5 kv, Number of pulse=10 times;
Test samples: (1) Nos. 1, 2, 3: SSWA 03 of the invention (anti-surge wire wound resistors, each including a 4 kΩ in paraller with a 2.7 kΩ, i.e. each being a three-layered stacking wire wound resistor,

(2) general wire wound resistors Nos. 4, 5, 6, respectively of 0.9920 kΩ, 0.9854 kΩ, 0.9888 kΩ;

After test: (1) the general wire wound resistors Nos. 4, 5, 6, being in explosion and becoming open at the first pulse, resulting in serious damage;

(2) the samples Nos. 1, 2, 3 according to the invention respectively becoming 1.0204 kΩ, 1.0128 kΩ and 1.0277 kΩ and all in a normal condition with the variation rate of the resistance value within 10%, rending the anti-surge capability raised above ten times.

TABLE 1
Defibrillator 5 KV Pulse Test
Test Condition:

| | SSWA03 | | | | |
|---|---|---|---|---|---|
| | VS. | | | | |
| | general | Resistance & | | | “ANSI/AAMI |
| | winding | Tolerance & | 1 KΩ ± 5% | | EC53 |
| Type | resistor | Watt | 3 W | Test standard | IEC 60601-2-27” |
| Lot size | | Lot no. | | Environment of | 26.5° C. 56% R.H. |
| | | | | test | |

Pulse Voltage = 5 KV
Number Of Pulse = 10 times
NO. 1, 2, 3: SSWA03 according to the invention (Superior Anti-Surge Wire Wound
Resistors)(4K//2K7//2K7)
NO. 4, 5, 6: general wire-wound resistors (1 KΩ)

| NO. | Pre-test | Post-test | Rate of change | Note |
|---|---|---|---|---|
| 1 | 0.9956 KΩ | 1.0204 KΩ | 2.491% | Absolute Average |
| The invention | | | | 2.042% |
| 2 | 1.0094 KΩ | 1.0128 KΩ | 0.337% | Average |
| The invention | | | | 2.042% |
| 3 | 0.9949 KΩ | 1.0277 KΩ | 3.298% | Maximum |
| The invention | | | | 3.298% |
| 4 | 0.9920 KΩ | OPEN | % | Minimum |
| A general wire | | (One time | | 0.337% |
| wound resistor | | pulse) | | Standard deviation |
| 5 | 0.9854 KΩ | OPEN | % | 1.250% |
| A general wire | | (One time | | |
| wound resistor | | pulse) | | |
| 6 | 0.9888 KΩ | OPEN | % | |
| A general wire | | (One time | | |
| wound resistor | | pulse) | | |
| 7 | | | | |
| 8 | | | | |
| 9 | | | | |
| 10 | | | | |

1. A stacking wire wound resistor, comprising:
a ceramic rod provided with a resistance value, being plated with a basic insulating layer thereon and having a first terminal and a second terminal;
a first wire wound resistor, including by a first metal wire, which has a first wire head and a first wire tail and is surroundingly wound from the first terminal of the ceramic rod provided with a resistance value to the second terminal of the ceramic rod provided with a resistance value, and a first insulating layer, being plated over the first metal wire; and
a second wire wound resistor, including a second metal wire, which has a second wire head and a second wire tail and is surroundingly wound over the first wire wound resistor from the first terminal of the ceramic rod provided with a resistance value to the second terminal of the ceramic rod provided with a resistance value, and by a second insulating layer, being plated over the second metal wire,
whereby the second wire wound resistor is stacked on the first wire wound resistor and on the ceramic rod provided with a resistance value to form a multi-layered, stacking wire wound resistor, and the ceramic rod provided with a resistance value, the first wire wound resistor and the second wire wound resistor constitute a predetermined circuit connection to enhance anti-surge property.

2. A stacking wire wound resistor of claim 1, further comprising a third wire wound resistor, which is stacked on the second wire wound resistor to become a three-layered, stacking resistor, and is formed by a third metal wire, having a third wire head and a third wire tail and being surroundingly wound over the second wire wound resistor from the first terminal of the ceramic rod provided with a resistance value to the third terminal of the ceramic rod provided with a resistance value, and by a third insulating layer, being plated over the third metal wire, wherein the third wire wound resistor is vertically stacked on the second wire wound resistor, and the ceramic rod provided with a resistance value, the first wire wound resistor, the second wire wound resistor and the third wire wound resistor are connected in parallel.

3. A stacking wire wound resistor of claim 1, wherein the predetermined circuit connection is in parallel, or the first metal wire and the second metal wire are wound inversely to form an inductanceless resistor.

4. A stacking wire wound resistor of claim 1, wherein the ceramic rod provided with a resistance value is a solid ceramic resistance rod, or a ceramic rod of high heat-dissipation combined with a metal film, a metal oxide film, a carbon film or a glass glaze.

5. A stacking wire would resistor of claim 1, further comprising a first cap and a second cap, being disposed respectively at one end of the ceramic rod provided with a resistance value and extending outwardly from the first terminal and the second terminal thereof, wherein the first wire head and the second wire head as well as the first wire tail and the second wire tail are respectively soldered onto a surface of the first cap and a surface of the second cap, wherein the first cap and the second cap are respectively electroplated with a first electroplated layer and a second electroplated layer, and wherein during plating, the plating of the basic insulting layer and the first insulating layer do not cover on the first cap and the second cap, and after completion that the second metal wire is surroundingly wound from the first terminal to the second terminal of the ceramic rod provided with a resistance value, soldering points of the wire head and the wire tail respectively of the first metal wire and the second metal wire are electroplated together for strengthening, and at the time of plating the second insulting layer for packing, the first cap and the second cap are plated as well.

6. A stacking wire wound resistor of claim 5, further comprising two externally connected metal leads, respectively extending outwardly along an axial direction respectively of the first cap and the second cap from the first electroplated layer and the second electroplated layer.

7. A stacking wire wound resistor of claim 5, wherein the material of the first cap and second cap is iron, silver, nichrome, copper or the alloy.

8. A stacking wire wound resistor of claim 2, wherein the material of the first insulating layer, the second insulating layer and the third insulating layer is eposy resin, silicone non-combustible paint, or enamel paint.

9. A stacking wire wound resistor of claim 6, wherein the material of the externally connected metal leads is copper alloy for raising heat-dissipating.

10. A method for manufacturing a stacking wire wound resistor, comprising:
providing a ceramic rod provided with a resistance value, and plating a basic insulating layer thereon, in which the ceramic rod provided with a resistance value has a first terminal and a second terminal;
forming a first wire wound resistor by providing a first metal wire, which has a first wire head and a first wire tail, winding the first metal wire from the first terminal of the ceramic rod provided with a resistance value to the second terminal of the ceramic rod provided with a resistance value, and plating a first insulating layer over the first metal wire; and
forming a second wire wound resistor by providing a second metal wire, which has a second wire head and a second wire tail, winding the second metal wire from the first terminal of the ceramic rod provided with a resistance value to the second terminal of the ceramic rod provided with a resistance value, and plating a second insulating layer over the second metal wire,
whereby the second wire wound resistor is stacked on the first wire wound resistor and on the ceramic rod provided with a resistance value to form a multi-layered, stacking wire wound resistor, and the ceramic rod provided with a resistance value, the first wire wound resistor and the second wire wound resistor constitute a predetermined circuit connection to enhance anti-surge property.

11. A method for manufacturing a stacking wire wound resistor of claim 10, further providing a third wire wound resistor, which is stacked on the second wire wound resistor.

12. A method for manufacturing a stacking wire wound resistor of claim 10, wherein the predetermined circuit connection is in parallel, or the first metal wire and the second metal wire are wound inversely to form an inductanceless resistor.

13. A method for manufacturing a stacking wire wound resistor of claim 10, wherein the ceramic rod provided with a resistance value is a solid ceramic resistance rod, or a ceramic rod of high heat-dissipation combined with a metal film, a metal oxide film, a carbon film or a glass glaze.

14. A method for manufacturing a stacking wire wound resistor of claim 10, further providing a first cap and a second cap, being disposed respectively at one end of the ceramic rod provided with a resistance value and extending outwardly from the first terminal and the second terminal thereof, wherein the first wire head and the second wire head as well as the first wire tail and the second wire tail are respectively soldered onto a surface of the first cap and a surface of the second cap, wherein the first cap and the second cap are respectively electroplated with a first electroplated layer and a second electroplated layer, and wherein during plating, the plating of the basic insulting layer and the first insulating layer do not plate on the first cap and the second cap, and after completion that the second metal wire is surroundingly wound from the first terminal to the second terminal of the ceramic rod provided with a resistance value, soldering points of the wire head and the wire tail respectively of the first metal wire and the second metal wire are electroplated together for strengthening, and at the time of plating the second insulting layer for packing, the first cap and the second cap are plated as well.

15. A method for manufacturing a stacking wire wound resistor of claim 14, further providing two externally connected metal leads, respectively extending outwardly along an axial direction respectively of the first cap and the second cap from the first electroplated layer and the second electroplated layer.

16. A method for manufacturing a stacking wire wound resistor of claim 14, wherein the material of the first cap and second cap is iron, silver, nichrome, copper or the alloy.

17. A method for manufacturing a stacking wire wound resistor of claim 11, wherein the material of the first insulating layer, the second insulating layer and the third insulating layer is eposy resin, silicone non-combustible paint, or enamel paint.

18. A method for manufacturing a stacking wire wound resistor of claim 15, wherein the material of the externally connected metal leads is copper alloy for raising heat-dissipating.
